(19) United States
(12) Patent Application Publication
(10) Pub. No.: US 2003/0135569 A1
(43) Pub. Date: Jul. 17, 2003

(54) Method and apparatus for delivering messages based on user presence, preference or location

(76) Inventors: Shabbir A. Khakoo, Morganville, NJ (US); Venkatesh Krishnaswamy, Holmdel, NJ (US); Anwar A. Siddiqui, New York, NY (US); Hal B. Zenner, Fair Haven, NJ (US)

Correspondence Address: Ryan, Mason & Lewis, LLP, Suite 205, 1300 Post Road, Fairfield, CT, 06430, US

(21) Appl. No.: 10/261,213

(22) Filed: Sep. 30, 2002

Related U.S. Application Data
(60) Provisional application No. 60/348,679, filed on Jan. 15, 2002.

(51) Int. Cl. G10L 21/00; G10L 11/00; G06F 15/16

(52) U.S. Cl. 709/206; 704/270

(57) ABSTRACT

A method and apparatus are disclosed for delivering messages to one or more intended recipients based on the presence, preferences or location of the recipient(s). Text-based messages, such as instant messages, can be delivered to one or more intended recipients by means of (i) a voice call to a voice-capable device associated with the recipients; (ii) a voice mail message to a voice mail box associated with the recipients; or (iii) a text or voice message, as appropriate, that is delivered upon the availability of one or more intended recipients. An instant message originating as a text message is converted to speech, if necessary, before being delivered to the intended recipient. The speech corresponding to the text of the message is played out once the call is answered or once the voice mail message is retrieved. The invention thus enables the delivery of messages to be routed and scheduled based on the location and availability of the intended recipient.

### CROSS REFERENCE TO RELATED APPLICATIONS

This application claims the benefit of U.S. Provisional Application No. 60/348,679, filed Jan. 15, 2002.

### FIELD OF THE INVENTION

The present invention relates generally to methods and systems for delivering messages over a network, and more particularly, to methods and systems that deliver messages to one or more intended recipients based on the presence, preferences or location of the recipient(s).

### BACKGROUND OF THE INVENTION

The consumer marketplace offers a number of systems that allow users to communicate. Instant messaging (IM) systems, for example, have become a popular means for communicating. Instant messages are usually entered into a computing device, such as a personal computer or personal digital assistant, as text. An instant message generally comprises a message body and one or more indicated recipients. An instant message is generally routed in real-time to the indicated recipients. Routing is “instant” within the parameters of the network(s) used to deliver the message and is subject to network delays, as well as reliability characteristics of the network.

An instant message is usually delivered and rendered immediately to the indicated recipients on a text capable device. If a given recipient is not present at the indicated device, however, the instant message is generally discarded. In some systems, such as paging systems, an instant message may be stored within the paging network and the recipient is provided with a paging message indicating that the instant message is available for retrieval. Thus, if the recipient is not present at the paging device, the recipient will be able to retrieve the instant message at a later time.

Currently available instant messaging systems are generally limited to a single-mode operation. Thus, an instant message that is entered by the sender as text can only be delivered to the indicated recipients as text using a text capable device. The intended recipient must be present at the text capable device to receive the message. A computing system associated with a visually impaired user may be specially configured to include a text-to-speech capability to convert the textual content that is presented on the user's computing device to speech. Nonetheless, the synthesized message is rendered immediately and the intended recipient must be present at the text-to-speech enabled device to receive the synthesized message. A need therefore exists for a method and apparatus for delivering messages to one or more intended recipients based on the presence, preferences or location of the recipient(s).

### SUMMARY OF THE INVENTION

Generally, a method and apparatus are disclosed that deliver messages to one or more intended recipients based on the presence, preferences or location of the recipient(s). A first aspect of the invention delivers text-based instant messages to one or more intended recipients by means of a voice call. An instant message originating as a text message is converted to speech before being delivered to the intended recipient by placing a voice call. The speech corresponding to the text of the message is played out once the call is answered. Thus, if the intended recipient is available at a voice-capable device, the text-based instant message is converted to speech using text-to-speech conversion techniques and delivered by means of a voice call.

A second aspect of the invention delivers text-based instant messages to one or more intended recipients by means of a voice mail message. An instant message originating as a text message is converted to a speech file before being delivered to the voice mailbox registered for the intended recipient. The speech file or message is retrieved by the intended recipient using the voice mail retrieval system. Thus, if the intended recipient is not available when the instant message is sent, the instant message can be converted to a speech file using text-to-speech technology and delivered to a designated voice mailbox.

A third aspect of the invention queues text-based instant messages pending the availability of one or more intended recipients. An instant message is delivered contingent upon the ability of the intended recipient to receive the message. Thus, the invention also enables the delivery of instant messages to be routed and scheduled based on the location and availability of the intended recipient. If the intended recipient is temporarily unable to receive the message, the message is queued for delivery until the recipient is available. When the intended recipient becomes available, the stored instant message is delivered (as a text or voice based message) to the text or voice capable device at which availability is established. For a text capable device, the instant message is delivered in its original text form. For a voice capable device, the instant message is converted to speech and delivered by placing a voice call.

A more complete understanding of the present invention, as well as further features and advantages of the present invention, will be obtained by reference to the following detailed description and drawings.

### BRIEF DESCRIPTION OF THE DRAWINGS

FIG. 1 illustrates an instant message delivery server incorporating features of the present invention;

FIG. 2 is a sample table from an exemplary presence database of FIG. 1; and

FIG. 3 is a flow chart describing an exemplary implementation of the instant message delivery process of FIG. 1.

### DETAILED DESCRIPTION

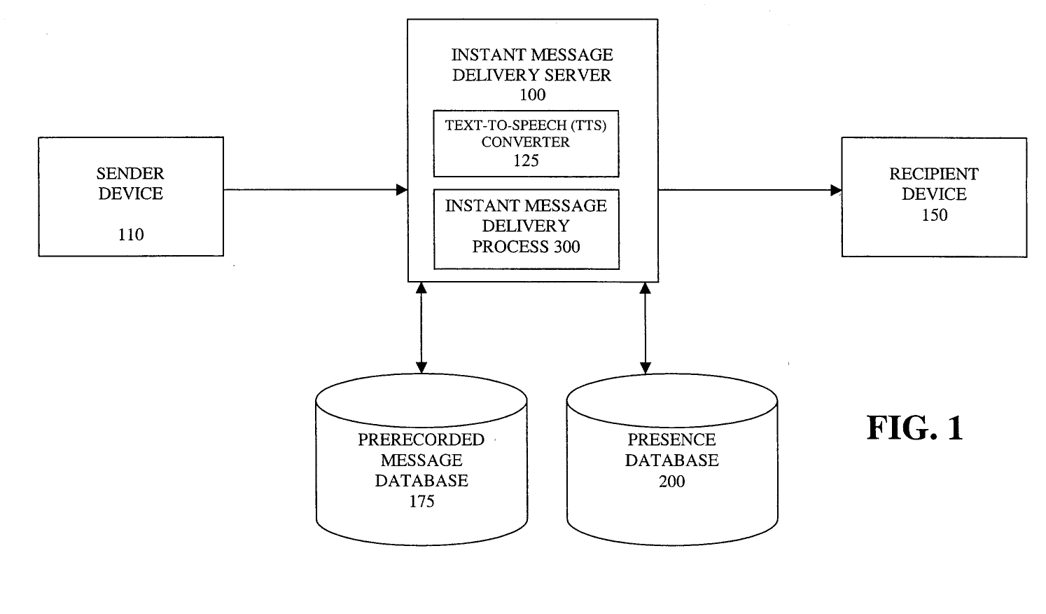

FIG. 1 illustrates an instant message delivery server 100 incorporating features of the present invention. The instant message delivery server 100 serves a community of users and is able to address a number of voice and text devices. As shown in FIG. 1, the instant message delivery server 100 receives an instant message from a user employing a sender device 110, such as a personal computer or personal digital assistant, for delivery to one or more intended recipients, each employing a text or voice capable recipient device 150. While the present invention is described in the context of an instant message system, it will be understood by those of ordinary skill in the art that the present invention encompasses other types of messages and is not limited to instant messages.

The present invention delivers instant messages to one or more intended recipients, based on the presence, preferences or location of the recipient(s). According to one aspect of the invention, text-based instant messages are delivered to one or more intended recipients through a voice call. Generally, an instant message that originates as a text message is converted to speech before being delivered to the intended recipient by placing a voice call. The speech corresponding to the text of the message is played out once the call is answered. For example, if the intended recipient is available at a voice-capable device, the text-based instant message is converted to speech using a text-to-speech converter 125 and then delivered by means of a voice call.

According to another aspect of the invention, text-based instant messages are delivered to one or more intended recipients by means of a voice mail message. Generally, an instant message that originates as a text message is converted to a speech file before being delivered to the voice mailbox associated with the intended recipient. The speech file or message corresponding to the text of the message can be retrieved by the intended recipient through the voice mail retrieval system. For example, if the recipient is not available when the instant message is sent, the instant message can be converted to a speech file using text-to-speech technology and delivered to a designated voice mailbox (or a voice mailbox otherwise associated with the intended recipient) where the stored speech file can be retrieved by the intended recipient using the voice mail retrieval system.

According to yet another aspect of the invention, text-based instant messages are queued pending availability of one or more intended recipients. Generally, an instant message is delivered contingent upon the ability of the intended recipient to receive the message. Thus, the invention also enables the delivery of instant messages to be routed and scheduled based on the location and availability of the intended recipient. If the intended recipient is temporarily unable to receive the message, for example, the message is queued for delivery until the recipient indicates availability. For example, if the recipient is not available when the instant message is sent, the instant message can be queued within the network system. When the intended recipient becomes available, the stored instant message is delivered (as a text or voice based message) to the text or voice capable device at which availability is established. For a text capable device, the instant message is delivered in its original text form. For a voice capable device, the instant message is converted to speech and delivered by placing a voice call.

As shown in FIG. 1, a user that wishes to send an instant message employs a text-enabled sender device 110, such as a personal computer or personal digital assistant, to enter the instant message as text. As previously indicated, the instant message generally comprises a message body and one or more indicated recipients. The instant message is received by the instant message delivery server 100 and is routed to the text or voice capable recipient device 150 associated with each intended recipient.

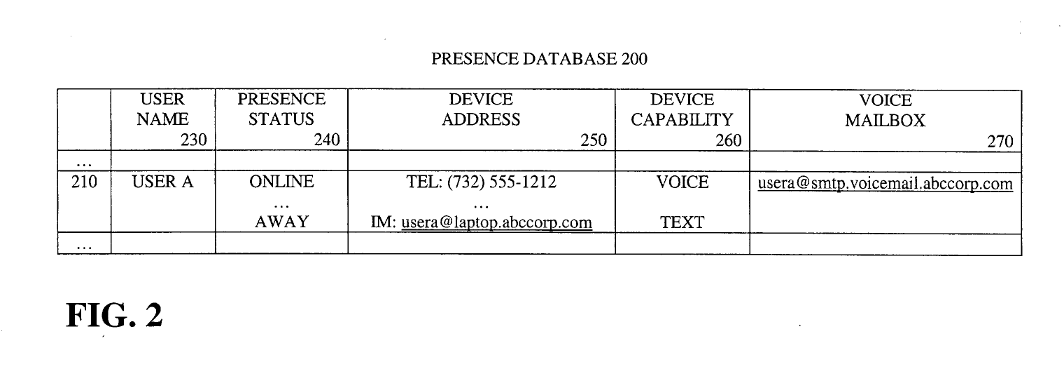

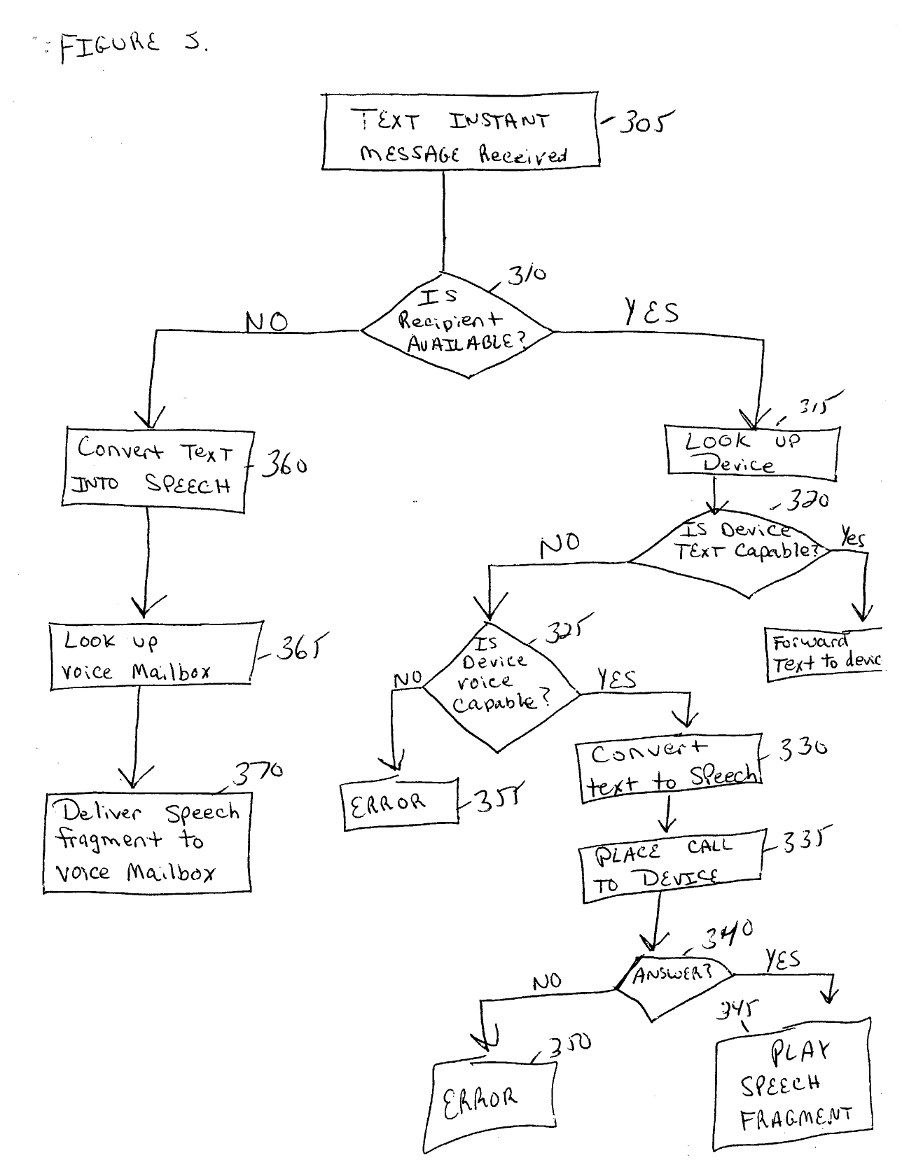

As shown in FIG. 1, the instant message delivery server 100 maintains a presence database 200, discussed below in conjunction with FIG. 2, to record information for each user in the community, including the availability of each user to receive instant messages. In addition, the instant message delivery server 100 employs an instant message delivery process 300, discussed further below in conjunction with FIG. 3, to process and deliver each instant message to one or more intended recipients based on the presence, preferences or location of the recipient(s). In a further variation, the instant message delivery server 100 can perform language translation to automatically synthesize the text message in a human language preferred by the user.

In one exemplary implementation, the instant message may be a custom message created by the user, or a code word associated with a predefined message. In the case of a custom message created by the user, the textual message is converted to speech by the text-to-speech converter 125. The text-to-speech converter 125 may be embodied using any commercially available text-to-speech conversion system. When the instant message includes a code word associated with a predefined message, the code word is used as an index into a prerecorded message database 175 to retrieve the appropriate recorded message. It is noted that the speech synthesis performed by the text-to-speech converter 125 or the storage of the prerecorded messages may be done centrally at the instant message delivery server 100, as shown in FIG. 1, or may alternatively be distributed to each recipient device 150, as would be apparent to a person of ordinary skill in the art.

FIG. 2 is a sample table from the exemplary presence database 200 of FIG. 1. As indicated above, the presence database 200 maintains information for each user in the community, including the availability of each user to receive instant messages. As shown in FIG. 2, the presence database 200 includes a plurality of records, such as record 210, each associated with a different user. For each user, identified, for example, by name in field 230, the presence database 200 indicates the user's presence in field 240, corresponding device address and capabilities in fields 250 and 260, respectively, and the user's voice mailbox in field 270. The presence entry in field 240 indicates whether the user is present at a given device registered for the user. The device address in field 250 indicates the address of each device that is available for receiving instant messages for the user. The address can be any location or connection means, such as a phone number or URL, for example. The device capability in field 260 indicates the capability of the device, such as whether the device is text or voice or video capable (or some combination of the foregoing), including email and fax capable devices. Finally, the voice mailbox in field 270 indicates the address of the voice mailbox for the user.

The instant message delivery server 100 updates the presence and device address entries based on the automatic detection of the presence of the user or by a process of manual registration by the user, in any known manner. Thus, the instant message delivery server 100 is always able to determine whether a user is available. If present, the server 100 is able to determine the address at which the user is available and the capabilities of the device at the address. In addition, the manual registration process allows a user to prioritize the indicated device and presence information, thereby allowing instant messages to be delivered in accordance with the user's preferences. It is noted that the presence database 200 can be embodied using a SIP registry database, discussed further below in the section entitled “SIP Overview.”

FIG. 3 is a flow chart describing an exemplary implementation of the instant message delivery process 300 of FIG. 1. As shown in FIG. 3, the instant message delivery process 300 is initiated during step 305 upon receipt by the instant message delivery server 100 of an instant message that originates as text and that is addressed to a user within the community serviced by the instant message delivery server 100. The instant message delivery server 100 performs a test during step 310 to determine if the recipient is available.

If it is determined during step 310 that the user is available, then the instant message delivery process 300 accesses the presence database 200 during step 315 to determine the device address and device capabilities for the user. A further test is performed during step 320 to determine if the device is text capable. If it is determined during step 320 that the device is text capable then the instant message is routed to the corresponding address. If it is determined during step 325 that the device is voice capable, then the instant message is converted to speech during step 330 using the text-to-speech converter 125. A voice call is placed to the address indicated for the voice-capable device during step 335. When it is determined during step 340 that the call is answered, the synthesized speech is played for the user during step 345. If it is determined during steps 320 and 325 that the users devices are neither text or voice capable, then an error is encountered during step 355. Likewise, if it is determined during step 340 that the user does not answer the call placed during step 335, then an error is encountered during step 350.

If, however, it was determined during step 310 that the user is unavailable, then the instant message delivery server 100 converts the text instant message to speech during step 360 using the text-to-speech converter 125. The presence database 200 is accessed during step 365 to determine the address of the voice mailbox and the speech is delivered as a voice mail message (i.e., a speech file) to the retrieved voice mailbox address during step 370.

The user can also specify rules that indicate the manner in which a given instant message should be processed, i.e., which devices to use, and when to contact them. Users may also automatically delegate some requests to other recipients. For a discussion of a suitable system for managing and processing the user specified rules, see, for example, PCT Application Serial Number PCT/US02/15513, filed May 14, 2002, entitled, “Method and Apparatus for Automatic Notification and Response Based On Communication Flow Expressions,” incorporated by reference herein and assigned to the assignee of the present invention.

### SIP Overview

Portable devices are increasingly establishing communications in accordance with the Session Initiation Protocol (SIP), described, for example, in M. Handley et al., “SIP: Session Initiation Protocol,” RFC 2543 (March 1999). Generally, SIP is an application level protocol used to establish multimedia sessions between two or more systems. Typically, SIP is used for setting up voice and video calls, conferencing calls, multicast sessions, and more recently instant messaging.

SIP can support the instant message delivery server 100 of the present invention with only a few changes. While SIP allows any two end-points to establish media sessions with each other, it also supports locating the end-points, exchanging the media information that enables the session to be established and closing down the session. SIP provides a registry where users can be associated with particular devices by registering a SIP Uniform Resource Locator (URL) for the device. A number of SIP proxies exist that support the ability to contact the list of URLs recorded in the registry for a given user in parallel or sequentially to establish communication with the user. Call Processing Language (CPL), as described, for example, in J. Lennox and H. Schulzrinne, “CPL: A Language for User Control of Internet Telephony Services,” Draft RFC draft-ietf-iptel-cpl-05.txt, November 2001, is a language that is proposed for SIP proxies.

CPL allows users to specify in advance how to select a specific URL given characteristics of a SIP INVITE message (that is used in accordance with the SIP protocol to establish contact with the user), such as interpretations of the strings in the sender and target addresses or the subject of the E. CPL also allows users to specify a timeout, so a sequential series of INVITE messages to specific devices can be tried when attempting to establish communication with the recipient. Moreover, SIP allows each SIP device or endpoint to specify the preferences of its user as a weighted list of media types and human languages. Senders are asked to provide, from the media types and human languages that they have available, the most highly weighted media type and human language.

Typically, every user sends a registration message (“REGISTER”) to a registration server, which stores the user's location. A SIP registration server typically also provides a location service. SIP registration servers thus receive registrations from users and they make this information available to SIP proxy servers. Registration servers typically require the user agent to be authenticated. In a conventional SIP network, the SIP proxy handles the routing of requests on behalf of a user agent, much as a proxy for HTTP handles web requests for client browsers. In many cases, the registrar is part of a SIP proxy system (i.e., they are located in the same physical system).

The user's location information is supplied to other users or proxies who query the location service of the registration server to obtain a particular user's address. Once the registration is completed, the registration information must be periodically refreshed to let the registrar know that the address for that user is still valid. The user is then ready to receive messages from other SIP users.

When a user A wants to send an instant message to another user B, the user A sends a SIP INVITE message to user B. This INVITE method is routed to user B through SIP proxies that are deployed in the network. User B responds to this INVITE message by accepting (200 OK response message) or rejecting (with an error response message) the message. Information about the session is sent in the exchanged INVITE and OK messages. SIP uses the Session Description Protocol (SDP), described, for example, in M. Handley and V. Jacobson, “SDP: Session Description Protocol,” RFC 2327 (April 1998), in the message body to give information about sessions (whether the underlying protocol is, e.g., TCP or UDP, port numbers of the caller and callee, and their respective contact addresses).

The SIP proxies receive requests from user agents and act on behalf of the user agent in forwarding or responding to the request. The proxy server does not issue a request, it only responds to requests from user agents. SIP proxies can either maintain state or be stateless. Proxies closer to the network edge usually maintain state, while those in the middle of the network can be stateless. The various types of SIP requests, called methods, are described in M. Handley et al., “SIP: Session Initiation Protocol,” RFC 2543 (March 1999), incorporated by reference herein.

It is to be understood that the embodiments and variations shown and described herein are merely illustrative of the principles of this invention and that various modifications may be implemented by those skilled in the art without departing from the scope and spirit of the invention.

We claim:

1. A method for delivering a text-based message to a recipient, comprising:
receiving said message from a sender;
converting a textual portion of said message to speech; and
delivering said speech to said recipient as a telephone call.

2. The method of claim 1, wherein said text-based message is an instant message.

3. The method of claim 1, wherein said converting step further comprises the step of retrieving a prerecorded message indexed by said text-based message.

4. The method of claim 1, wherein said converting step further comprises the step of synthesizing said textual portion to speech.

5. The method of claim 1, wherein said text-based message is processed in accordance with the SIP protocol.

6. The method of claim 1, wherein said delivering step is conditioned upon an availability of said recipient.

7. The method of claim 1, wherein said delivering step is conditioned upon an availability of said recipient at a voice-capable device.

8. A method for delivering a text-based message to a recipient, comprising:
receiving said message from a sender;
evaluating an availability of said recipient to receive said message;
converting a textual portion of said message to a speech file; and
delivering said speech file to said recipient as a voice mail message.

9. The method of claim 8, wherein said text-based message is an instant message.

10. The method of claim 8, wherein said converting step further comprises the step of retrieving a prerecorded message indexed by said text-based message.

11. The method of claim 8, wherein said converting step further comprises the step of synthesizing said textual portion to a speech file.

12. The method of claim 8, wherein said text-based message is processed in accordance with the SIP protocol.

13. The method of claim 8, wherein said delivering step further comprises the step of retrieving an indication of a voice mailbox associated with said recipient.

14. A method for delivering a message to a recipient, comprising:
receiving said message from a sender;
evaluating an availability of said recipient to receive said message; and
delivering said message to said recipient when said recipient is available.

15. The method of claim 14, wherein said message is an instant message.

16. The method of claim 14, wherein said message is delivered to a text-enabled device associated with said recipient.

17. The method of claim 14, wherein said message is delivered to a voice-enabled device associated with said recipient.

18. The method of claim 17, further comprising the step of retrieving a prerecorded message indexed by a text-based message.

19. The method of claim 17, further comprising the step of synthesizing a textual portion of a text-based message to speech.

20. The method of claim 14, wherein said message is processed in accordance with the SIP protocol.

21. A system for delivering a text-based message to a recipient, comprising:
a memory that stores computer-readable code; and
a processor operatively coupled to said memory, said processor configured to implement said computer-readable code, said computer-readable code configured to:
receive said message from a sender;
convert a textual portion of said message to speech; and
deliver said speech to said recipient as a telephone call.

22. A system for delivering a text-based message to a recipient, comprising:
a memory that stores computer-readable code; and
a processor operatively coupled to said memory, said processor configured to implement said computer-readable code, said computer-readable code configured to:
receive said message from a sender;
evaluate an availability of said recipient to receive said message;
convert a textual portion of said message to speech; and
deliver said speech to said recipient as a voice mail message.

23. A system for delivering a message to a recipient, comprising:
a memory that stores computer-readable code; and
a processor operatively coupled to said memory, said processor configured to implement said computer-readable code, said computer-readable code configured to:
receive said message from a sender;
evaluate an availability of said recipient to receive said message; and
deliver said message to said recipient when said recipient is available.

24. An article of manufacture for delivering a text-based message to a recipient, said article of manufacture comprising:
a computer readable medium having computer readable code means embodied thereon, said computer readable program code means comprising:
a step to receive said message from a sender;
a step to convert a textual portion of said message to speech; and
a step to deliver said speech to said recipient as a telephone call.

25. An article of manufacture for delivering a text-based message to a recipient, said article of manufacture comprising:
a computer readable medium having computer readable code means embodied thereon, said computer readable program code means comprising:
a step to receive said message from a sender;
a step to evaluate an availability of said recipient to receive said message;
a step to convert a textual portion of said message to speech; and
a step to deliver said speech to said recipient as a voice mail message.

26. An article of manufacture for delivering a message to a recipient, said article of manufacture comprising:
a computer readable medium having computer readable code means embodied thereon, said computer readable program code means comprising:
a step to receive said message from a sender;
a step to evaluate an availability of said recipient to receive said message; and
a step to deliver said message to said recipient when said recipient is available.
